(19) United States
(12) Patent Application Publication
(10) Pub. No.: US 2026/0106774 A1
(43) Pub. Date: Apr. 16, 2026

(54) COMMUNICATION SYSTEM

(71) Applicant: DENSO CORPORATION, Kariya-city (JP)

(72) Inventors: Tomoya TOKUNAGA, Kariya-city (JP); Yoji HOMMA, Kariya-city (JP); Akira TADA, Kariya-city (JP)

(21) Appl. No.: 19/354,906

(22) Filed: Oct. 10, 2025

(30) Foreign Application Priority Data
Oct. 15, 2024 (JP) 2024-179770

(51) Int. Cl. H04L 12/40; H04L 12/12

(52) U.S. Cl. CPC H04L 12/40039; H04L 12/12; H04L 2012/40215; H04L 2012/40273

(57) ABSTRACT

A communication system includes a plurality of electronic control units transmitting and receiving a communication frame. The electronic control units includes a first control device configured to receive power supply via a first power supply path, a second control device configured to receive power supply via a second power supply path not connected to the first power supply path, a first slave device configured to receive power supply via a third power supply path connected to the first power supply path, a second slave device configured to receive power supply via a fourth power supply path connected to the second power supply path, and a management device configured to generate a management frame including state specifying information.

### CROSS REFERENCE TO RELATED APPLICATION

This application is based on Japanese Patent Application No. 2024-179770 filed on October 15, 2024, the disclosure of which is incorporated herein by reference.

### TECHNICAL FIELD

The present disclosure relates to a communication system including a plurality of electronic control units.

### BACKGROUND

A related art discloses an in-vehicle network system including a power relay for individually switching the power supply on/off for each of a plurality of electronic control units, in which control content for switching the power supply on/off of a specific electronic control unit corresponding to a scene specified based on the situation of the vehicle is determined, and, based on the determined control content, the power supply on/off to the specific electronic control unit is switched using the power relay.

### SUMMARY

According to an aspect of the present disclosure, a communication system includes a plurality of electronic control units connected for transmitting and receiving a communication frame, the electronic control units including: a first control device configured to receive power supply via a first power supply path; a second control device configured to receive power supply via a second power supply path not connected to the first power supply path; a first slave device configured to receive power supply via a third power supply path connected to the first power supply path; a second slave device configured to receive power supply via a fourth power supply path connected to the second power supply path; and a management device configured to generate a management frame, which is the communication frame including state specifying information capable of specifying whether each of the plurality of electronic control units is to be set to an on state or an off state in accordance with a detected event, a first communication path configured to connect the management device and the first control device for transmitting and receiving the communication frame between the management device and the first control device, a second communication path configured to connect the management device and the second control device for transmitting and receiving the communication frame between the management device and the second control device, and a relay communication path configured to connect the first control device and the second control device for transmitting and receiving the communication frame between the first control device and the second control device. The management device may transmit the management frame to the first control device via the first communication path. The management device may transmit the management frame to the second control device via the second communication path. The first control device and the first slave device may be connected to enable data communication with each other. The second control device and the second slave device may be connected to enable data communication with each other.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing the configuration of a vehicle control system;

FIG. 2 is a flowchart illustrating the frame transmission processing;

FIG. 3 is a flowchart illustrating the frame transfer processing;

FIG. 4 is a flowchart illustrating the failure detection processing;

FIG. 5 is a flowchart illustrating the master activation processing;

FIG. 6 is a flowchart illustrating the slave activation processing;

FIG. 7 is a flowchart illustrating the restart processing;

FIG. 8 is a flowchart illustrating the master stop processing;

FIG. 9 is a flowchart illustrating the slave stop processing;

FIG. 10 is a flowchart illustrating the terminal stop processing; and

FIG. 11 is a flowchart illustrating the abnormality detection processing.

### DETAILED DESCRIPTION

As a result of extensive study by the inventors, it has been found that, in a communication system including a plurality of electronic control units and configured to individually switch each electronic control unit between an on state and an off state, there may arise a case in which switching between the on state and the off state of the electronic control unit becomes impossible.

The present disclosure provides a technique to suppress the inability to switch the electronic control unit between the on state and the off state.

According to one aspect of the present disclosure, a communication system comprises a plurality of electronic control units connected for transmitting and receiving a communication frame. The electronic control units includes: a first control device configured to receive power supply via a first power supply path; a second control device configured to receive power supply via a second power supply path not connected to the first power supply path; a first slave device configured to receive power supply via a third power supply path connected to the first power supply path; a second slave device configured to receive power supply via a fourth power supply path connected to the second power supply path; and a management device configured to generate a management frame, which is the communication frame including state specifying information capable of specifying whether each of the plurality of electronic control units is to be set to an on state or an off state in accordance with a detected event. The communication system comprises a first communication path configured to connect the management device and the first control device for transmitting and receiving the communication frame between the management device and the first control device, a second communication path configured to connect the management device and the second control device for transmitting and receiving the communication frame between the management device and the second control device, and a relay communication path configured to connect the first control device and the second control device for transmitting and receiving the communication frame between the first control device and the second control device. The management device is configured to transmit the management frame to the first control device via the first communication path. The management device is configured to transmit the management frame to the second control device via the second communication path. The first control device and the first slave device are connected to enable data communication with each other. The second control device and the second slave device are connected to enable data communication with each other.

In the communication system of the present disclosure configured as described above, since the management device generates a management frame in accordance with an event and transmits the management frame to the first and second control devices via the first and second communication paths, the first control device, the second control device, the first slave device, and the second slave device can be set to the on state or the off state in accordance with the event.

Further, in the communication system of the present disclosure, even if the management device is unable to transmit a management frame to the first control device via the first communication path, the management device can transmit the management frame to the first control device via the second communication path and the relay communication path. Furthermore, the first control device can transmit the management frame to the first slave device.

In addition, in the communication system of the present disclosure, even if the management device is unable to transmit a management frame to the second control device via the second communication path, the management device can transmit the management frame to the second control device via the first communication path and the relay communication path. Furthermore, the second control device can transmit the management frame to the second slave device.

Therefore, the communication system of the present disclosure can suppress the inability to switch between the on state and the off state in the first control device, the second control device, the first slave device, and the second slave device.

Furthermore, in the communication system of the present disclosure, even if the first control device becomes unable to receive power supply via the first power supply path, the second control device, which receives power supply via the second power supply path not connected to the first power supply path, can operate. Therefore, the communication system of the present disclosure can suppress the inability to simultaneously switch between the on state and the off state in both the first and second slave devices.

As described above, the communication system of the present disclosure can suppress the inability to switch between the on state and the off state in the first control device, the second control device, the first slave device, and the second slave device.

According to one aspect of the present disclosure, a communication system includes a plurality of electronic control units connected for transmitting and receiving a communication frame. The electronic control units includes a first control device configured to receive power supply via a first power supply path, and a second control device configured to receive power supply via a second power supply path not connected to the first power supply path. The communication system includes a first power supply switching unit configured to switch a third power supply path, which supplies power to a first slave device connected to the first power supply path and is connected to enable data communication with the first control device, between an on state in which the third power supply path is conductive and an off state in which the third power supply path is interrupted; a second power supply switching unit configured to switch a fourth power supply path for supplying power to a second slave device, which is connected to the second power supply path and is connected to enable data communication with the second control device, between an on state in which the fourth power supply path is conductive and an off state in which the fourth power supply path is interrupted; a management device, as the electronic control unit, configured to generate a management frame, which is the communication frame including state specifying information capable of specifying whether each of the plurality of electronic control units is to be set to an on state or an off state in accordance with a detected event; a first communication path configured to connect the management device and the first control device for transmitting and receiving the communication frame between the management device and the first control device; a second communication path configured to connect the management device and the second control device for transmitting and receiving the communication frame between the management device and the second control device; and a relay communication path configured to connect the first control device and the second control device for transmitting and receiving the communication frame between the first control device and the second control device. The management device is configured to transmit the management frame to the first control device via the first communication path. The management device is configured to transmit the management frame to the second control device via the second communication path. The first control device is configured to control operation of the first power supply switching unit based on the state specifying information included in the management frame. The second control device is configured to control operation of the second power supply switching unit based on the state specifying information included in the management frame.

In the communication system of the present disclosure configured as described above, since the management device generates a management frame in accordance with an event and transmits the management frame to the first and second control devices via the first and second communication paths, the first and second control devices can set the first and second power supply switching units to the on state or the off state in accordance with the event.

Further, in the communication system of the present disclosure, even if the management device is unable to transmit a management frame to the first control device via the first communication path, the management device can transmit the management frame to the first control device via the second communication path and the relay communication path. In addition, in the communication system of the present disclosure, even if the management device is unable to transmit a management frame to the second control device via the second communication path, the management device can transmit the management frame to the second control device via the first communication path and the relay communication path. Therefore, the communication system of the present disclosure can suppress the inability to switch between permission and prohibition of power supply to the first and second slave devices.

Furthermore, in the communication system of the present disclosure, even if the first control device becomes unable to control the operation of the first power supply switching unit due to being unable to receive power supply via the first power supply path, the second control device, which receives power supply via the second power supply path not connected to the first power supply path, can control the operation of the second power supply switching unit. Therefore, the communication system of the present disclosure can suppress the inability to simultaneously switch between permission and prohibition of power supply to both the first and second slave devices.

As described above, the communication system of the present disclosure can suppress the inability to switch between the on state and the off state in the first slave device and the second slave device.

### First Embodiment

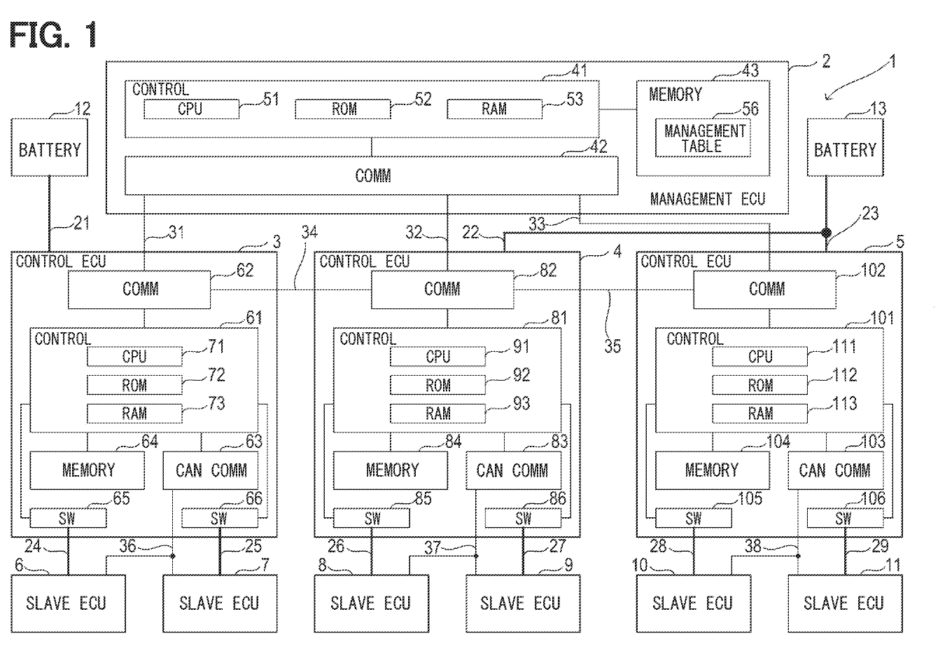

The first embodiment of the present disclosure will be described below with reference to the drawings. The vehicle control system 1 of the present embodiment is mounted on a vehicle and, as shown in FIG. 1, includes a management electronic control unit (management ECU) 2, control electronic control units (control ECU) 3, 4, and 5, slave electronic control units (slave ECU) 6, 7, 8, 9, 10, and 11, and batteries 12 and 13. "ECU" stands for Electronic Control Unit.

The management ECU 2 achieves coordinated control of the entire vehicle by supervising the control ECUs 3, 4, and 5. The control ECUs 3, 4, and 5 are provided for each zone into which the vehicle is divided, and mainly execute control of the slave ECUs present within their respective zones.

The slave ECUs 6 and 7 are ECUs belonging to the same zone as the control ECU 3. The slave ECUs 8 and 9 are ECUs belonging to the same zone as the control ECU 4. The slave ECUs 10 and 11 are ECUs belonging to the same zone as the control ECU 5.

The batteries 12 and 13 are direct current batteries (for example, 12V) that supply electric power to various parts of the vehicle. The control ECU 3 receives power supply from the battery 12 via a first power supply path 21 between the battery 12 and the control ECU 3.

The control ECU 4 receives power supply from the battery 13 via a second power supply path 22 between the battery 13 and the control ECU 4. The control ECU 5 receives power supply from the battery 13 via a third power supply path 23 between the battery 13 and the control ECU 5.

Each of the slave ECUs 6 and 7 receives power supply from the battery 12 via power supply paths 24 and 25, respectively, between the control ECU 3 and the slave ECUs 6 and 7. Each of the slave ECUs 8 and 9 receives power supply from the battery 13 via power supply paths 26 and 27, respectively, between the control ECU 4 and the slave ECUs 8 and 9.

Each of the slave ECUs 10 and 11 receives power supply from the battery 13 via power supply paths 28 and 29, respectively, between the control ECU 5 and the slave ECUs 10 and 11. The management ECU 2 and the control ECU 3 are connected so as to enable data communication with each other via a first communication line 31.

The management ECU 2 and the control ECU 4 are connected so as to enable data communication with each other via a second communication line 32. The management ECU 2 and the control ECU 5 are connected so as to enable data communication with each other via a third communication line 33.

The control ECU 3 and the control ECU 4 are connected so as to enable data communication with each other via a communication line 34. The control ECU 4 and the control ECU 5 are connected so as to enable data communication with each other via a communication line 35.

The control ECU 3 and the slave ECUs 6 and 7 are connected so as to enable data communication with each other via a communication bus 36. The control ECU 4 and the slave ECUs 8 and 9 are connected so as to enable data communication with each other via a communication bus 37.

The control ECU 5 and the slave ECUs 10 and 11 are connected so as to enable data communication with each other via a communication bus 38. The management ECU 2 includes a control unit 41, a communication unit 42, and a storage unit 43.

The control unit 41 is an electronic control unit centered on a microcomputer including a CPU 51, ROM 52, RAM 53, and the like. Various functions of the microcomputer are realized by the CPU 51 executing programs stored in a non-transitory tangible recording medium. In this example, the ROM 52 corresponds to the non-transitory tangible recording medium storing the program. Further, by executing this program, a method corresponding to the program is executed. Note that some or all of the functions executed by the CPU 51 may be configured in hardware by one or more ICs or the like. Also, the number of microcomputers constituting the control unit 41 may be one or more.

The communication unit 42 performs communication by transmitting and receiving communication frames, for example, based on the Ethernet communication protocol, between the management ECU 2 and the control ECU 3 connected via the communication line 31, between the management ECU 2 and the control ECU 4 connected via the communication line 32, and between the management ECU 2 and the control ECU 5 connected via the communication line 33. Ethernet is a registered trademark.

The storage unit 43 is a storage device for storing various types of data. The storage unit 43 stores a management table 56, which will be described later. The control ECU 3 includes a control unit 61, a communication unit 62, a CAN communication unit 63, a storage unit 64, and power distribution switches 65 and 66. CAN stands for Controller Area Network.

The control unit 61 is an electronic control unit centered on a microcomputer including a CPU 71, ROM 72, RAM 73, and the like. Various functions of the microcomputer are realized by the CPU 71 executing programs stored in a non-transitory tangible recording medium. In this example, the ROM 72 corresponds to the non-transitory tangible recording medium storing the program. Further, by executing this program, a method corresponding to the program is executed. Note that some or all of the functions executed by the CPU 71 may be configured in hardware by one or more ICs or the like. Also, the number of microcomputers constituting the control unit 61 may be one or more.

The communication unit 62 performs communication by transmitting and receiving communication frames, for example, based on the Ethernet communication protocol, between the control ECU 3 and the management ECU 2 connected via the communication line 31, and between the control ECU 3 and the control ECU 4 connected via the communication line 34.

The CAN communication unit 63 performs communication by transmitting and receiving communication frames based on the CAN communication protocol between the control ECU 3 and the slave ECUs 6 and 7 connected via the communication bus 36. The storage unit 64 is a storage device for storing various types of data.

The power distribution switch 65 is disposed on the power supply path 24 connected to the power supply path 21. The power distribution switch 65 is configured to switch the power supply path 24 to connect or disconnect (also referred to as conduction or interruption) in accordance with a command from the control unit 61.

The power distribution switch 66 is disposed on the power supply path 25 connected to the power supply path 21. The power distribution switch 66 is configured to switch the power supply path 25 to connect or disconnect in accordance with a command from the control unit 61.

The control ECU 4 includes a control unit 81, a communication unit 82, a CAN communication unit 83, a storage unit 84, and power distribution switches 85 and 86. The control unit 81 is an electronic control unit centered on a microcomputer including a CPU 91, ROM 92, RAM 93, and the like. Various functions of the microcomputer are realized by the CPU 91 executing programs stored in a non-transitory tangible recording medium. In this example, the ROM 92 corresponds to the non-transitory tangible recording medium storing the program. Further, by executing this program, a method corresponding to the program is executed. Note that some or all of the functions executed by the CPU 91 may be configured in hardware by one or more ICs or the like. Also, the number of microcomputers constituting the control unit 81 may be one or more.

The communication unit 82 performs communication by transmitting and receiving communication frames, for example, based on the Ethernet communication protocol, between the control ECU 4 and the management ECU 2 connected via the communication line 32, between the control ECU 4 and the control ECU 3 connected via the communication line 34, and between the control ECU 4 and the control ECU 5 connected via the communication line 35.

The CAN communication unit 83 performs communication by transmitting and receiving communication frames based on the CAN communication protocol between the control ECU 4 and the slave ECUs 8 and 9 connected via the communication bus 37. The storage unit 84 is a storage device for storing various types of data.

The power distribution switch 85 is disposed on the power supply path 26 connected to the power supply path 22. The power distribution switch 85 is configured to switch the power supply path 26 to connect or disconnect in accordance with a command from the control unit 81.

The power distribution switch 86 is disposed on the power supply path 27 connected to the power supply path 22. The power distribution switch 86 is configured to switch the power supply path 27 to connect or disconnect in accordance with a command from the control unit 81.

The control ECU 5 includes a control unit 101, a communication unit 102, a CAN communication unit 103, a storage unit 104, and power distribution switches 105 and 106. The control unit 101 is an electronic control unit centered on a microcomputer including a CPU 111, ROM 112, RAM 113, and the like. Various functions of the microcomputer are realized by the CPU 111 executing programs stored in a non-transitory tangible recording medium. In this example, the ROM 112 corresponds to the non-transitory tangible recording medium storing the program. Further, by executing this program, a method corresponding to the program is executed. Note that some or all of the functions executed by the CPU 111 may be configured in hardware by one or more ICs or the like. Also, the number of microcomputers constituting the control unit 101 may be one or more.

The communication unit 102 performs communication by transmitting and receiving communication frames, for example, based on the Ethernet communication protocol, between the control ECU 5 and the management ECU 2 connected via the communication line 33, and between the control ECU 5 and the control ECU 4 connected via the communication line 35.

The CAN communication unit 103 performs communication by transmitting and receiving communication frames based on the CAN communication protocol between the control ECU 5 and the slave ECUs 10 and 11 connected via the communication bus 38. The storage unit 104 is a storage device for storing various types of data.

The power distribution switch 105 is disposed on the power supply path 28 connected to the power supply path 23. The power distribution switch 105 is configured to switch the power supply path 28 to connect or disconnect in accordance with a command from the control unit 101.

The power distribution switch 106 is disposed on the power supply path 29 connected to the power supply path 23. The power distribution switch 106 is configured to switch the power supply path 29 to connect or disconnect in accordance with a command from the control unit 101.

In the management table 56, for each of a plurality of events, the correspondence between the event and the power distribution switches to be set to the on state and those to be set to the off state is established. Specifically, in the management table 56, for each event, six switching information items are set, indicating whether each of the power distribution switches 65, 66, 85, 86, 105, and 106 should be set to the on state or the off state.

For example, regarding an event in which the vehicle power state switches from accessory on state to ignition on state, as the six switching information items, for example, the power distribution switch 65 is set to the on state, the power distribution switch 66 is set to the on state, the power distribution switch 85 is set to the off state, the power distribution switch 86 is set to the off state, the power distribution switch 105 is set to the on state, and the power distribution switch 106 is set to the off state.

For example, regarding a door open event in which the vehicle door is opened, as the six switching information items, for example, the power distribution switch 65 is set to the off state, the power distribution switch 66 is set to the off state, the power distribution switch 85 is set to the on state, the power distribution switch 86 is set to the on state, the power distribution switch 105 is set to the off state, and the power distribution switch 106 is set to the on state.

For example, when the slave ECU 6 is a door control ECU, if the door switch is turned to the on state, the slave ECU 6 transmits information indicating a door open event to the management ECU 2 via the control ECU 4. As a result, the management ECU 2 can detect the occurrence of the door open event.

When the management ECU 2 detects an event, it extracts from the management table 56 the six switching information items corresponding to the detected event. The management ECU 2 then generates a communication frame including the extracted six switching information items as a network management (NM) frame and transmits the generated NM frame. NM stands for Network Management.

When the control ECU 3 receives the NM frame transmitted by the management ECU 2, it extracts the switching information for the subordinate power distribution switches 65 and 66 from the NM frame, and sets the power distribution switches 65 and 66 to the on state or the off state based on the extracted switching information.

When the control ECU 4 receives the NM frame transmitted by the management ECU 2, it extracts the switching information for the subordinate power distribution switches 85 and 86 from the NM frame, and sets the power distribution switches 85 and 86 to the on state or the off state based on the extracted switching information.

When the control ECU 5 receives an NM frame transmitted by the management ECU 2, it extracts the switching information for the subordinate power distribution switches 105 and 106 from the NM frame, and sets the power distribution switches 105 and 106 to the on state or the off state based on the extracted switching information.

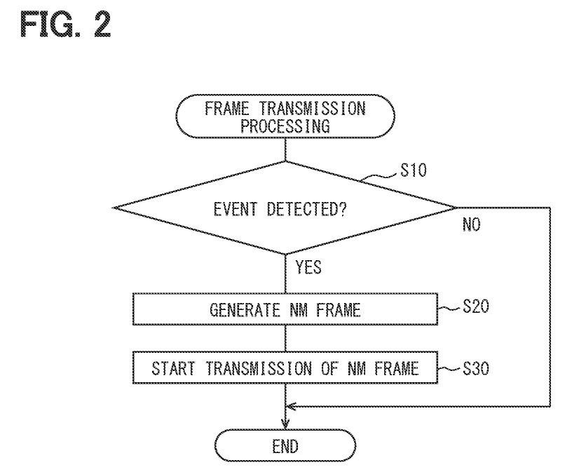

Next, the procedure for frame transmission processing executed by the control unit 41 of the management ECU 2 will be described. The frame transmission processing is a process that is repeatedly executed during the operation of the management ECU 2. When the frame transmission processing is executed, the CPU 51 of the control unit 41, as shown in FIG. 2, determines in S10 whether an event has been detected. If no event is detected, the CPU 51 terminates the frame transmission processing.

On the other hand, if an event is detected, the CPU 51, in S20, extracts from the management table 56 the six switching information items corresponding to the detected event, and generates an NM frame including the extracted six switching information items.

In S30, the CPU 51 initiates the process of transmitting the NM frame generated in S20 to the control ECUs 3, 4, and 5 via the respective communication lines 31, 32, and 33, and terminates the frame transmission processing. As a result, the management ECU 2 periodically and repeatedly transmits the NM frame generated in S20.

Next, the procedure for frame forwarding processing executed by the control units 61, 81, and 101 of the control ECUs 3, 4, and 5 will be described. The frame forwarding processing is a process that is repeatedly executed during the operation of the control ECUs 3, 4, and 5.

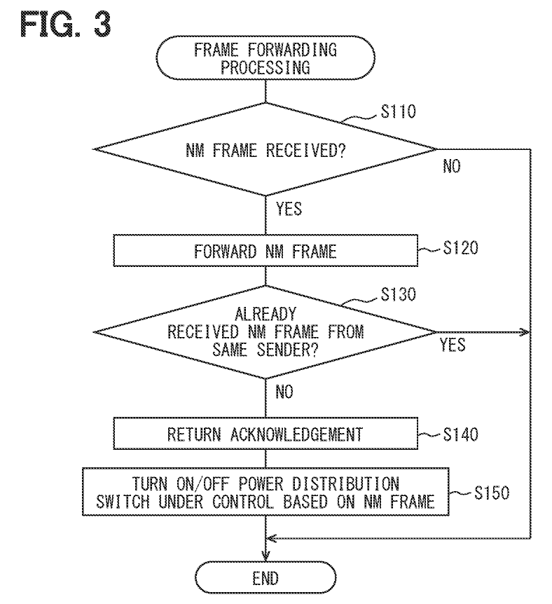

When the frame forwarding processing is executed, the CPUs 71, 91, and 111 of the control units 61, 81, and 101, as shown in FIG. 3, determine in S110 whether an NM frame has been received. If no NM frame is received, the CPUs 71, 91, and 111 terminate the frame forwarding processing.

On the other hand, if an NM frame is received, the CPUs 71, 91, and 111, in S120, forward the received NM frame via the remaining communication lines, excluding the communication lines 31, 32, and 33 connected to the management ECU 2 and the communication line through which the NM frame was received in S110.

For example, when the control ECU 3 receives an NM frame from the management ECU 2 via the communication line 31, it forwards the NM frame to the control ECU 4 via the communication line 34. If the control ECU 3 receives an NM frame from the control ECU 4 via the communication line 34, it does not forward the NM frame.

For example, when the control ECU 4 receives an NM frame from the management ECU 2 via the communication line 32, it forwards the NM frame to the control ECUs 3 and 5 via the communication lines 34 and 35, respectively. If the control ECU 4 receives an NM frame from the control ECU 3 via the communication line 34, it forwards the NM frame to the control ECU 5 via the communication line 35.

If the control ECU 4 receives an NM frame from the control ECU 5 via the communication line 35, it forwards the NM frame to the control ECU 3 via the communication line 34. When the control ECU 5 receives an NM frame from the management ECU 2 via the communication line 33, it forwards the NM frame to the control ECU 4 via the communication line 35.

If the control ECU 5 receives an NM frame from the control ECU 4 via the communication line 35, it does not forward the NM frame. In S130, the CPUs 71, 91, and 111 determine, within a period (hereinafter referred to as the same frame reception determination period) between a predetermined time before the time point at which it is determined in S110 that an NM frame has been received and the time point at which it is determined in S110 that an NM frame has been received, whether an NM frame from the same sender (i.e., the management ECU 2) has already been received. Note that the NM frame includes a sender address indicating the sender.

The same frame reception determination period is set based on the difference in timing of receiving NM frames via multiple communication lines when the control ECU receives NM frames via a plurality of communication lines.

For example, in the control ECU 4, the same frame reception determination period is set based on the differences in timing when receiving an NM frame via the communication line 31, when receiving an NM frame via the communication lines 32 and 34, and when receiving an NM frame via the communication lines 33, 34, and 35. The same frame reception determination period may be the same for the control ECUs 3, 4, and 5, or may be different for each of the control ECUs 3, 4, and 5.

Here, if an NM frame from the same sender has already been received within the same frame reception determination period, the CPUs 71, 91, and 111 terminate the frame forwarding processing. On the other hand, if an NM frame from the same sender has not been received within the same frame reception determination period, the CPUs 71, 91, and 111, in S140, return an acknowledgment via the communication line through which the NM frame was received in S110.

For example, when the control ECU 4 receives an NM frame from the management ECU 2 via the communication line 32, it returns an acknowledgment to the management ECU 2 via the communication line 32. Also, when the control ECU 4 receives an NM frame from the control ECU 3 via the communication line 34, it returns an acknowledgment to the control ECU 3 via the communication line 34.

In S150, the CPUs 71, 91, and 111 set the subordinate power distribution switches to the on state or the off state based on the switching information included in the NM frame received in S110, and terminate the frame forwarding processing.

Next, the procedure for failure detection processing executed by the control units 61, 81, and 101 of the control ECUs 3, 4, and 5 will be described. The failure detection processing is a process that is repeatedly executed during the operation of the control ECUs 3, 4, and 5.

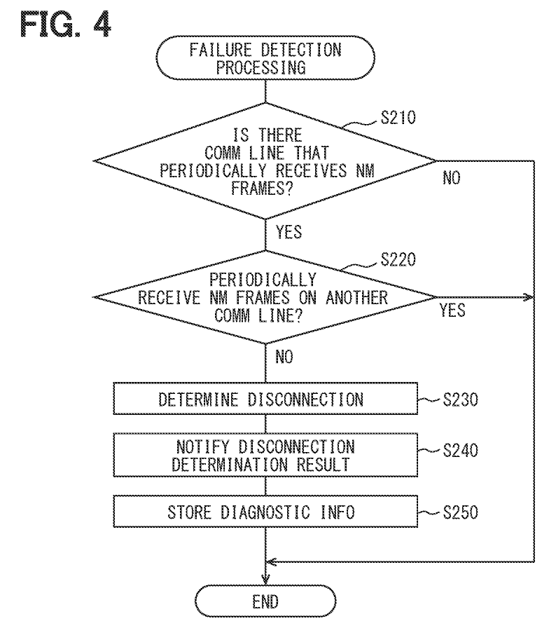

When the failure detection processing is executed, the CPUs 71, 91, and 111 of the control units 61, 81, and 101, as shown in FIG. 4, determine in S210 whether there is currently a communication line on which NM frames are being received periodically. If there is no communication line on which NM frames are being received periodically at present, the CPUs 71, 91, and 111 terminate the failure detection processing.

On the other hand, if there is currently a communication line on which NM frames are being received periodically, the CPUs 71, 91, and 111, in S220, determine whether NM frames are being received periodically at present on other communication lines besides the communication line identified in S210.

If NM frames are being received periodically at present on other communication lines besides the communication line identified in S210, the CPUs 71, 91, and 111 terminate the failure detection processing. On the other hand, if NM frames are not being received periodically at present on other communication lines besides the communication line identified in S210, the CPUs 71, 91, and 111, in S230, determine that communication interruption has occurred on the communication line on which NM frames are not being received periodically at present.

For example, if the communication line 32 is disconnected, the control ECU 4 periodically receives NM frames from the control ECUs 3 and 5 via the communication lines 34 and 35, but cannot receive NM frames from the management ECU 2 via the communication line 32. Therefore, the control ECU 4 determines that communication interruption has occurred on the communication line 32.

For example, if the communication line 34 is disconnected, the control ECU 4 periodically receives NM frames from the management ECU 2 and the control ECU 5 via the communication line 32 and the communication line 35, but cannot receive NM frames from the control ECU 3 via the communication line 34. Therefore, the control ECU 4 determines that communication interruption has occurred on the communication line 34.

For example, if the communication line 31 is disconnected, the control ECU 3 periodically receives NM frames from the control ECU 4 via the communication line 34, but cannot receive NM frames from the management ECU 2 via the communication line 31. Therefore, the control ECU 3 determines that communication interruption has occurred on the communication line 31.

In S240, the CPUs 71, 91, and 111 notify the management ECU 2 of an interruption determination result indicating the communication line where communication interruption has occurred. Upon receiving the interruption determination result, the management ECU 2, as a fail-safe action, stores diagnostic information indicating the received interruption determination result in the storage unit 43. Additionally, upon receiving the interruption determination result, the management ECU 2 may notify the vehicle occupants that a communication interruption has occurred.

In S250, the CPUs 71, 91, and 111 store the diagnostic information indicating the interruption determination result notified in S240 in the storage units 64, 84, and 104, and terminate the failure detection processing. Note that this failure detection processing may be omitted when the communication partner control ECU is in a sleep state.

As configured above, the vehicle control system 1 includes ECUs 2-11 connected so as to enable transmission and reception of communication frames. The vehicle control system 1 includes the control ECU 3, the control ECU 4, the slave ECU 6, the slave ECU 8, the management ECU 2, the communication line 31, the communication line 32, and the communication line 34.

The control ECU 3 is configured to receive power supply via the power supply path 21. The control ECU 4 is configured to receive power supply via the power supply path 22, which is not connected to the power supply path 21.

The slave ECU 6 is configured to receive power supply via the power supply path 24 connected to the power supply path 21. The slave ECU 8 is configured to receive power supply via the power supply path 26 connected to the power supply path 22.

The power distribution switch 65 is configured to switch between an on state in which the power supply path 24 is in conduction and an off state in which the power supply path 24 is in interruption. The power distribution switch 85 is configured to switch between an on state in which the power supply path 26 is in conduction and an off state in which the power supply path 26 is in interruption.

The management ECU 2 is configured to generate an NM frame, which is a communication frame including switching information indicating whether to set the slave ECU 6 and the slave ECU 8 to the on state or the off state, in accordance with a detected event.

The communication line 31 is a communication path that connects the management ECU 2 and the control ECU 3 so as to enable transmission and reception of communication frames between the management ECU 2 and the control ECU 3. The communication line 32 is a communication path that connects the management ECU 2 and the control ECU 4 so as to enable transmission and reception of communication frames between the management ECU 2 and the control ECU 4.

The communication line 34 is a communication path that connects the control ECU 3 and the control ECU 4 so as to enable transmission and reception of communication frames between the control ECU 3 and the control ECU 4. The management ECU 2 is configured to transmit an NM frame to the control ECU 3 via the communication line 31.

The management ECU 2 is configured to transmit an NM frame to the control ECU 4 via the communication line 32. The control ECU 3 and the slave ECU 6 are connected so as to enable data communication with each other.

The control ECU 4 and the slave ECU 8 are connected so as to enable data communication with each other. In such a vehicle control system 1, since the management ECU 2 generates an NM frame in accordance with an event and transmits the NM frame to the control ECUs 3 and 4 via the communication lines 31 and 32, the slave ECUs 6 and 8 can be set to the on state or the off state in accordance with the event.

Further, in the vehicle control system 1, even if the management ECU 2 is unable to transmit an NM frame to the control ECU 3 via the communication line 31, the management ECU 2 can transmit the NM frame to the control ECU 3 via the communication line 32 and the communication line 34. Furthermore, the control ECU 3 can transmit the NM frame to the slave ECU 6.

In addition, in the vehicle control system 1, even if the management ECU 2 is unable to transmit an NM frame to the control ECU 4 via the communication line 32, the management ECU 2 can transmit the NM frame to the control ECU 4 via the communication line 31 and the communication line 34. Furthermore, the control ECU 4 can transmit the NM frame to the slave ECU 8.

Therefore, the vehicle control system 1 can suppress the inability to switch between the on state and the off state in the slave ECUs 6 and 8. Furthermore, in the vehicle control system 1, even if the control ECU 3 becomes unable to receive power supply via the power supply path 21, the control ECU 4, which receives power supply via the power supply path 22 not connected to the power supply path 21, can operate. Accordingly, the vehicle control system 1 can suppress the inability to simultaneously switch between the on state and the off state in both the slave ECUs 6 and 8.

As described above, the vehicle control system 1 can suppress the inability to switch between the on state and the off state in the electronic control units. Further, the vehicle control system 1 includes a power distribution switch 65 and a power distribution switch 85.

The power distribution switch 65 is configured to switch between an on state in which the power supply path 24 is in conduction and an off state in which the power supply path 24 is in interruption. The power distribution switch 85 is configured to switch between an on state in which the power supply path 26 is in conduction and an off state in which the power supply path 26 is in interruption.

The control ECU 3 is configured to control the operation of the power distribution switch 65 based on the switching information included in the NM frame. The control ECU 4 is configured to control the operation of the power distribution switch 85 based on the switching information included in the NM frame.

In such a vehicle control system 1, by controlling the operation of the power distribution switches 65 and 85, it is possible to switch between the on state and the off state in the slave ECUs 6 and 8. Further, even when the control ECU 3 is able to utilize the communication line 32, it is configured to transmit the NM frame received from the management ECU 2 to the control ECU 4 via the communication line 34. Similarly, even when the control ECU 4 is able to utilize the communication line 31, it is configured to transmit the NM frame received from the management ECU 2 to the control ECU 3 via the communication line 34. In such a vehicle control system 1, the control ECUs 3 and 4 transmit the NM frame via the communication line 34 even during normal operation when both communication lines 31 and 32 are available. Therefore, the vehicle control system 1 can omit processing for determining whether the communication lines 31 and 32 are available.

Further, the vehicle control system 1 includes a control ECU 5, a slave ECU 10, a power distribution switch 105, a communication line 33, and a communication line 35. The control ECU 5 is configured to receive power supply via the power supply path 23, which is not connected to the power supply path 21 nor the power supply path 22, but is connected to the power supply path 22.

The slave ECU 10 is configured to receive power supply via the power supply path 28 connected to the power supply path 23. The power distribution switch 105 is configured to switch between an on state in which the power supply path 28 is in conduction and an off state in which the power supply path 28 is in interruption.

The communication line 33 is a communication path that connects the management ECU 2 and the control ECU 5 so as to enable transmission and reception of communication frames between the management ECU 2 and the control ECU 5. The communication line 35 is a communication path that connects the control ECU 4 and the control ECU 5 so as to enable transmission and reception of communication frames between the control ECU 4 and the control ECU 5.

The NM frame further includes switching information indicating whether to set the power distribution switch 105 to the on state or the off state. The management ECU 2 is configured to transmit the NM frame to the control ECU 5 via the communication line 35.

The control ECU 5 is configured to control the operation of the power distribution switch 105 based on the switching information included in the NM frame. In such a vehicle control system 1, even when the communication lines 31 and 32 cannot be utilized, the NM frame can be transmitted to the control ECUs 3 and 4 via the communication lines 33, 34, and 35, thereby further suppressing the inability to switch between permission and prohibition of power supply to the slave ECUs 6 and 8.

Furthermore, the control ECU 3 is configured such that, when NM frames are received from each of the communication lines 31 and 34 connected to the control ECU 3 within a predetermined same frame reception determination period, the power distribution switch 65 is set to the on state or the off state based on the earliest received NM frame. The control ECU 4 is configured such that, when NM frames are received from each of the communication lines 32, 34, and 35 connected to the control ECU 4 within a predetermined same frame reception determination period, the power distribution switch 85 is set to the on state or the off state based on the earliest received NM frame. The control ECU 5 is configured such that, when NM frames are received from each of the communication lines 33 and 35 connected to the control ECU 5 within a predetermined same frame reception determination period, the power distribution switch 105 is set to the on state or the off state based on the earliest received NM frame. NM frames that are not the earliest received are discarded after reception.

In such a vehicle control system 1, when the control ECUs 3, 4, and 5 receive the same NM frame multiple times, it is possible to avoid unnecessary repeated execution of the same control for the power distribution switches 65, 85, and 105 by the control ECUs 3, 4, and 5.

Further, each of the control ECUs 3, 4, and 5 is configured to determine that communication interruption has occurred on any communication line 31-35 that is not periodically receiving an NM frame, when a management frame is periodically received on at least one of the communication lines 31-35 connected to the respective control ECU and an NM frame is not periodically received on at least one of the communication lines 31-35 connected to the respective control ECU.

Such a vehicle control system 1 can specify the communication lines 31-35 where an abnormality has occurred. Furthermore, each of the control ECUs 3, 4, and 5 is configured to notify the management ECU 2 of the interruption determination result when communication interruption is determined to have occurred.

Such a vehicle control system 1 enables the management ECU 2 to recognize the communication line 31-35 where an abnormality has occurred. In the embodiments described above, the vehicle control system 1 corresponds to the communication system, the ECUs 2-11 correspond to the electronic control units, the management ECU 2 corresponds to the management device, the control ECU 3 corresponds to the first control device, and the control ECU 4 corresponds to the second control device.

Additionally, the slave ECU 6 corresponds to the first slave device, the slave ECU 8 corresponds to the second slave device, the power distribution switch 65 corresponds to the first power supply switching unit, and the power distribution switch 85 corresponds to the second power supply switching unit.

The power supply path 21 corresponds to the first power supply path, the power supply path 22 corresponds to the second power supply path, the power supply path 24 corresponds to the third power supply path, and the power supply path 26 corresponds to the fourth power supply path. The communication line 31 corresponds to the first communication path, the communication line 32 corresponds to the second communication path, the communication line 34 corresponds to the relay communication path, the NM frame corresponds to the management frame, and the switching information corresponds to the state specifying information.

Moreover, the control ECU 5 corresponds to the third control device, the slave ECU 10 corresponds to the third slave device, the power distribution switch 105 corresponds to the third power supply switching unit, the power supply path 23 corresponds to the fifth power supply path, the power supply path 28 corresponds to the sixth power supply path, the communication line 33 corresponds to the third communication path, and the communication line 35 corresponds to the second relay communication path.

Additionally, the same frame reception determination period corresponds to the first same frame reception determination period and the second same frame reception determination period. The processing executed by the control unit 61 in S210-S230 corresponds to the processing of the first communication interruption determination unit, and the processing executed by the control unit 81 in S210-S230 corresponds to the processing of the second communication interruption determination unit.

Furthermore, S240 executed by the control unit 61 corresponds to the processing of the first interruption notification unit, and S240 executed by the control unit 81 corresponds to the processing of the second interruption notification unit.

### Second Embodiment

Since the basic configuration of the second embodiment is the same as that of the first embodiment, only the differences will be described below. Note that the same reference numerals as in the first embodiment indicate identical components, and reference should be made to the preceding description.

In the first embodiment described above, the management ECU 2 transmits NM frames to each of the plurality of communication lines 31-33, and the control ECUs 3, 4, and 5 are configured to relay NM frames to each other. In contrast, in the second embodiment, the communication path to be utilized for each communication partner (for example, the communication path normally used) is predetermined, and the management ECU 2 transmits NM frames only to one communication line 31-33 corresponding to the communication path set for the designated communication partner. The NM frame is then relayed according to the designated communication path, which differs from the first embodiment.

As described above, in the vehicle control system 1 of the second embodiment, the communication path is predetermined for each communication partner. Specifically, in the storage unit 43 of the management ECU 2 and the storage units 64, 84, and 104 of the control ECUs 3, 4, and 5, information regarding the communication path to be used for each communication partner is stored in a rewritable manner. Information regarding the communication path includes, for example, information about the port corresponding to the communication line 31-38 to be used for each communication partner, and other necessary information for communication along the designated communication path.

The communication path between each device constituting the vehicle control system 1 (i.e., the management ECU 2, control ECUs 3, 4, 5, and slave ECUs 6-11) is basically set so that the number of hops is minimized. For example, the communication path from the management ECU 2 to the slave ECU 6 is set so that communication is performed in the order of communication line 31, control ECU 3, and communication bus 36. Also, for example, the communication path from the slave ECU 8 to the management ECU 2 is set so that communication is performed in the order of communication bus 37, control ECU 4, and communication line 32. Furthermore, for example, the communication path from the slave ECU 6 to the slave ECU 8 is set so that communication is performed in the order of communication bus 36, control ECU 3, communication line 34, control ECU 4, and communication bus 37.

In the second embodiment, assuming that communication interruption occurs, a plurality of processes are provided to enable proper relaying of NM frames in such cases. These processes include (A) a process for activating the slave ECU and (B) a process for stopping the slave ECU.

First, as the process (A) for activating the slave ECU, the process for activating the slave ECU 6 will be described. Note that the process described below is not limited to the process for activating the slave ECU 6, but can be applied to processes for transmitting NM frames to a designated communication partner.

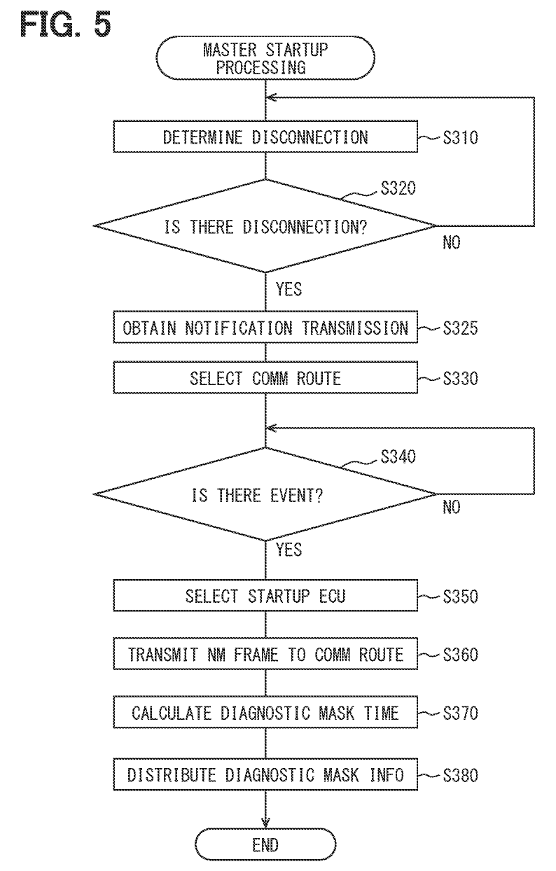

FIG. 5 is a flowchart showing the master activation process. The master activation process is a process that starts, for example, when the management ECU 2 is activated, and is executed by the CPU 51 of the management ECU 2.

In the master activation process, as shown in FIG. 5, first, the CPU 51 of the management ECU 2 performs interruption determination in S310. This process is the same as S230 described above. That is, in this process, communication interruption is detected. Note that in this process, for example, abnormalities in the communication path such as disconnection or excessive delay may also be detected.

Next, in S320, the CPU 51 of the management ECU 2 determines whether communication interruption has occurred. If there is no communication interruption, the process returns to S310. If there is communication interruption, the process proceeds to S325. Then, in S325, the CPU 51 of the management ECU 2 notifies the management ECU 2 internally of the detected abnormality. That is, the function for notifying abnormality in the management ECU 2 sends an abnormality notification, and the function for selecting the communication path in the management ECU 2 (for example, the function in S330 described below) acquires the abnormality notification. The abnormality notification is a notification including information for specifying the abnormal part (for example, one of the communication lines 31-35) where the abnormality has occurred among the plurality of communication paths.

Subsequently, when the CPU 51 of the management ECU 2 receives the abnormality notification in S330, it selects a new communication path that avoids the abnormal section. Specifically, for example, in the communication path from the management ECU 2 to the slave ECU 6 shown in FIG. 1, if the communication path includes the communication line 31 and the communication bus 36, and communication interruption is detected on the communication line 31, a new communication path that avoids the communication line 31 is established.

The management ECU 2 stores a routing map in the storage unit 43, which is a set of selectable communication paths configured based on which communication paths each device is connected through. For example, as a new communication path that avoids the communication line 31, the management ECU 2 selects a route from the management ECU 2 via the communication line 32, control ECU 4, communication line 34, control ECU 3, and communication bus 36 to the slave ECU 6.

The management ECU 2 stores both the new communication path and the communication path used before abnormality detection (hereinafter referred to as the previous communication path) in the storage unit 43. These new and previous communication paths can be read from the storage unit 43 when the management ECU 2 is restarted.

Next, in S340, the CPU 51 of the management ECU 2 determines whether an event has occurred. The event here may be the same as the event in S10 described above, or may be another event. In one example of this embodiment, it is determined whether there is an event that requires activation of the slave ECU 6. If there is no event, S340 is repeated. If there is an event, the process proceeds to S350.

Next, in S350, the CPU 51 of the management ECU 2 selects the ECU to be activated in accordance with the event. In one example of this embodiment, the slave ECU 6 is selected. Then, in S360, the CPU 51 of the management ECU 2 transmits an NM frame to the new communication path. This NM frame includes a configuration notification and an activation command. The configuration notification is a notification to the devices constituting the new communication path, including the control ECUs 3, 4, and 5, that communication will be conducted via the selected new communication path. The activation command is a command to activate the slave ECU 6.

Next, in S370, the management ECU 2 is configured to calculate the diagnostic mask time. The diagnostic mask time is the time until a newly joined device (for example, control ECU 3) in the network operates normally. The diagnostic mask time is calculated based on the known activation time of the slave ECU 6.

Note that each ECU constituting the vehicle control system 1 is configured to transmit a diagnostic (for example, error code) when communication with the target ECU is interrupted (for example, timeout). In this embodiment, each ECU ignores frames related to the newly joined device in the network only during the diagnostic mask time. Thus, diagnostic masking refers to temporarily ignoring frames from the target ECU so that, even if communication is determined to be interrupted by any ECU, it is not regarded as abnormal.

Further, the diagnostic mask time may be set in consideration of an increase in communication delay time as the communication path lengthens. Not only the diagnostic mask time, but also other times such as the SW OFF time described later may be set in consideration of increased communication delay time.

When there is no communication interruption, the diagnostic mask time for the slave ECU 6 is, for example, a value calculated based on the activation time of the slave ECU 6 and the delay time on the previous communication path (for example, communication line 31 and communication bus 36). On the other hand, when there is communication interruption, the diagnostic mask time is a value calculated based on the activation time of the slave ECU 6 and the delay time on the new communication path (for example, including control ECU 4, communication line 32, communication line 34, and communication bus 36).

Note that each device constituting the vehicle control system 1 may perform time synchronization by determining the timing for transmitting and receiving signals according to a common time. In this case, time synchronization may be corrected according to communication delay time. That is, the time held by each ECU may be corrected in consideration of communication delay time to enable accurate synchronization. Further, control timing may be adjusted in consideration of communication delay time. For example, control timing may be adjusted so that the ECU that receives the frame last receives it at the appropriate timing.

When the diagnostic mask time is set for each device with respect to its communication partner device, signals related to the corresponding communication partner device are ignored during the diagnostic mask time. More specifically, for example, during the diagnostic mask time for the slave ECU 6, signals related to the slave ECU 6 are ignored by all devices.

Next, in S380, the CPU 51 of the management ECU 2 is configured to notify at least the plurality of control ECUs 3, 4, and 5 of the diagnostic mask information. The diagnostic mask information includes the diagnostic mask time. When this process is completed, the present processing ends. Note that the diagnostic mask time may also be notified from the control ECU 3 to the slave ECUs 6 and 7, from the control ECU 4 to the slave ECUs 8 and 9, and from the control ECU 5 to the slave ECUs 10 and 11.

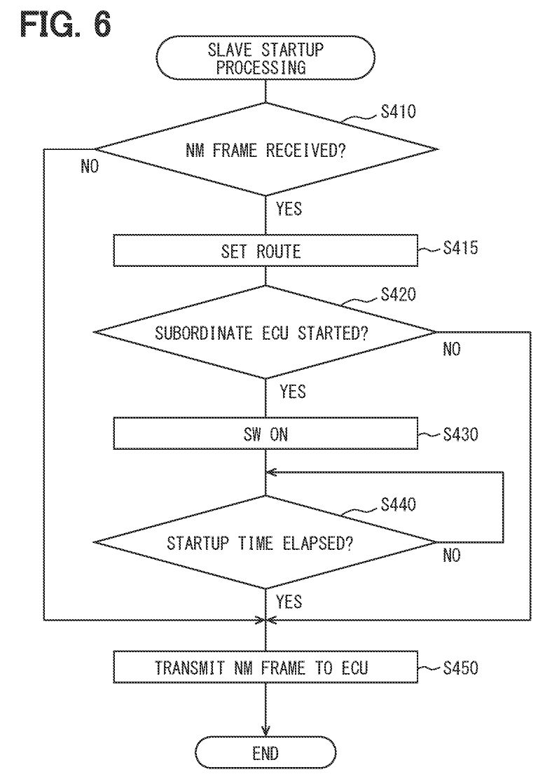

Next, FIG. 6 is a flowchart showing the slave activation processing (also referred to as slave startup processing) executed by the CPUs 71, 91, and 111 (hereinafter referred to as CPU 71, etc.) of the plurality of control ECUs 3, 4, and 5, respectively, for activating the slave ECUs 6-11. The slave activation processing is a process that starts, for example, when the power supply to the control ECUs 3, 4, and 5 is turned on.

In the slave activation processing, as shown in FIG. 6, first, in S410, the CPU 71, etc., determines whether an NM frame has been received. The NM frame here may include a configuration notification and an activation command transmitted by the management ECU 2.

Next, in S415, the CPU 71, etc., sets the communication to be performed via the new communication path according to the configuration notification. The CPU 71, etc., stores the new communication path and the previous communication path in the storage units 64, 84, and 104. These new and previous communication paths can be read from the storage units 64, 84, and 104 when the CPU 71, etc., is restarted.

Next, in S420, the CPU 71, etc., determines whether to activate the subordinate ECU according to the NM frame. The subordinate ECUs refer to the slave ECUs 6-11 subordinate to the control ECUs 3, 4, and 5, slave ECUs 6 and 7 are subordinate to control ECU 3, slave ECUs 8 and 9 are subordinate to control ECU 4, and slave ECUs 10 and 11 are subordinate to control ECU 5. Note that the control ECUs 3, 4, and 5 may also be regarded as subordinate ECUs from the perspective of the management ECU 2.

In S420, for example, in the case of control ECU 4, if there is no need to activate the subordinate ECU and the NM frame is simply relayed, a negative determination is made. In the case of control ECU 3, if the slave ECU 6 is to be activated, a positive determination is made. If the subordinate ECU is not to be activated, the process proceeds to S450. If the subordinate ECU is to be activated, the process proceeds to S430.

Next, in S430, the CPU 71, etc., sets the power distribution switch corresponding to the subordinate ECU to the on state. As a result, power is supplied to the subordinate ECU and the ECU is activated. For example, when the control ECU 3 turns on the power supply to the slave ECU 6 (i.e., supplies power), the power distribution switch 65 is set to the on state.

Next, in S440, the CPU 71, etc., determines whether the activation time has elapsed. The activation time is the time from when the power supply to the subordinate ECU is turned on until activation is completed. The activation time is generally the same as the diagnostic mask time. If the activation time has not elapsed, S440 is repeated. If the activation time has elapsed, the process proceeds to S450.

Next, in S450, the CPU 71, etc., transmits the NM frame to the next relay control ECU or the subordinate ECU. The NM frame transmitted here may include a configuration notification and an activation command, similar to the NM frame received from the management ECU 2. However, when transmitting the NM frame to the subordinate ECU, since the subordinate ECU has already been activated, the activation command is unnecessary. When this process is completed, the present processing ends.

The NM frame may include not only an activation command, but also stop information described later, or a command to wake up or put the ECU into a sleep state. If the subordinate ECU is in a sleep state, in S430 described above, the control ECUs 3, 4, and 5 may transmit a wake-up command to the subordinate ECU. Furthermore, if the subordinate ECU is configured to recognize the NM frame even in the sleep state, it is possible to omit transmission of the wake-up command from the control ECUs 3, 4, and 5. Additionally, the subordinate ECU may receive the NM frame transmitted in S450 and wake itself up.

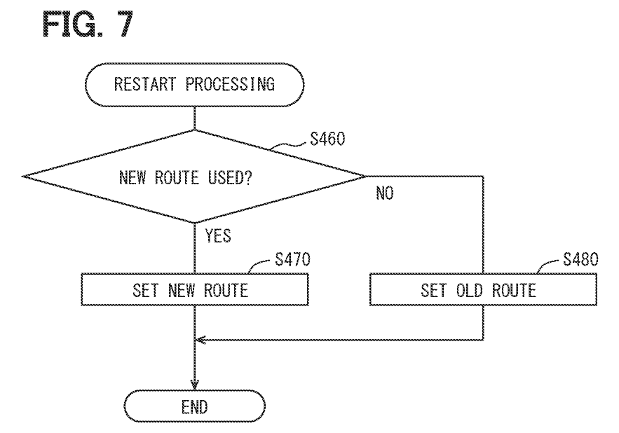

Next, FIG. 7 is a flowchart showing the restart processing. The restart processing is a process that starts, for example, when the management ECU 2 enters a sleep or power-off state due to ignition off or the like after a change in the communication path, and then the management ECU 2 is restarted. This process is executed by the CPU 51 of the management ECU 2.

Subsequently, in S460, the CPU 51 of the management ECU 2 determines whether it is set to use the new communication path. Here, when the management ECU 2 is restarted after communication interruption has been detected, it is predetermined whether communication is to be performed using the new communication path or the previous communication path (i.e., the communication path before the communication interruption). This setting can be arbitrarily changed and is shared with each device constituting the network via the NM frame or the like. If the new communication path is to be used, the process proceeds to S470. If the previous communication path is to be used, the process proceeds to S480.

Next, in S470, the CPU 51 of the management ECU 2 sets the system to use the new communication path. In this case, communication is resumed using the new communication path without using the previous communication path.

On the other hand, in S480, the CPU 51 of the management ECU 2 sets the system to use the previous communication path. In this case, if communication interruption is detected again in the master activation processing (also referred to as master startup processing) described above, the new communication path will be used. When these processes are completed, the restart processing ends. Whether to use the new communication path or the previous communication path is notified to each device via the configuration notification in the NM frame.

Next, as process (B) for stopping the slave ECU, the process for stopping the slave ECU 6 will be described. Note that the process described below is not limited to stopping the slave ECU 6, but can also be applied to processes such as putting the slave ECU 6 into sleep mode, where a waiting time must be considered and the NM frame is transmitted to a specified communication partner.

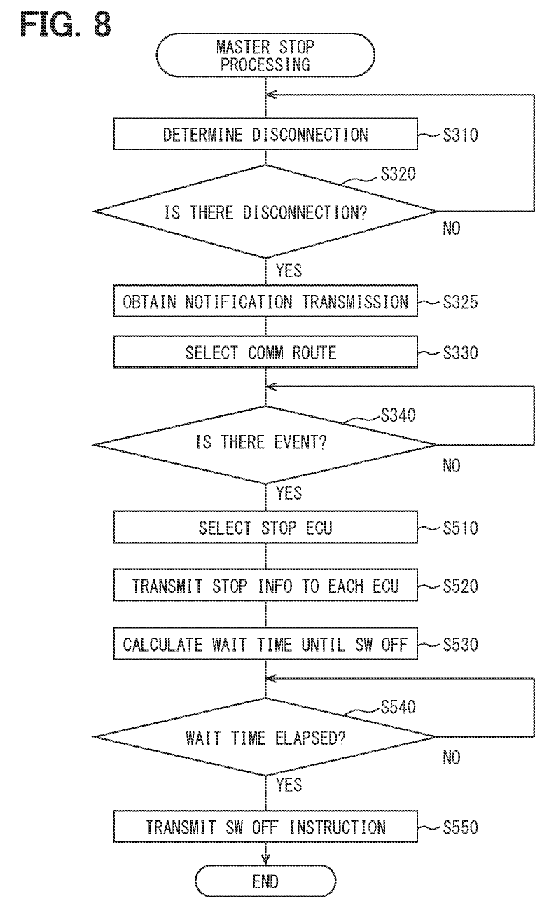

FIG. 8 is a flowchart showing the master stop processing. The master stop processing is a process that starts, for example, when the management ECU 2 is activated, and is executed by the CPU 51 of the management ECU 2.

Steps S310 to S340 in the master stop processing are the same as steps S310 to S340 in the master activation processing. As shown in FIG. 8, when an event occurs in S340, the process proceeds to S510.

Next, in S510, the CPU 51 of the management ECU 2 selects the ECU to be stopped in accordance with the event. In one example of this embodiment, the slave ECU 6 is selected. Then, in S520, the CPU 51 of the management ECU 2 transmits an NM frame to the new communication path. This NM frame includes stop information for stopping the slave ECU 6 and the configuration notification described above. The stop information is sequentially transmitted along the new communication path.

Next, in S530, the CPU 51 of the management ECU 2 calculates the waiting time until SW OFF (i.e., SW OFF time or off waiting time). The waiting time until SW OFF is the time required for the shutdown sequence of the slave ECU 6 to be completed and for the power distribution switch 65 to be set to the off state. This time is set in consideration of the time required for the slave ECU 6 to perform the shutdown sequence after receiving the stop information. The time required for the slave ECU 6 to shut down is known in advance.

Next, in S540, the CPU 51 of the management ECU 2 determines whether the waiting time has elapsed since the waiting time was set. If the waiting time has not elapsed, S540 is repeated. If the waiting time has elapsed, the process proceeds to S550.

Subsequently, in S550, the CPU 51 of the management ECU 2 transmits an NM frame in order to execute processing related to the slave ECU 6. Specifically, to stop power supply to the slave ECU 6, an NM frame including an SW OFF instruction, which is an instruction to set the power distribution switch 65 to the off state, is transmitted. This NM frame is sequentially transmitted along the new communication path. When this processing is completed, the master stop processing ends.

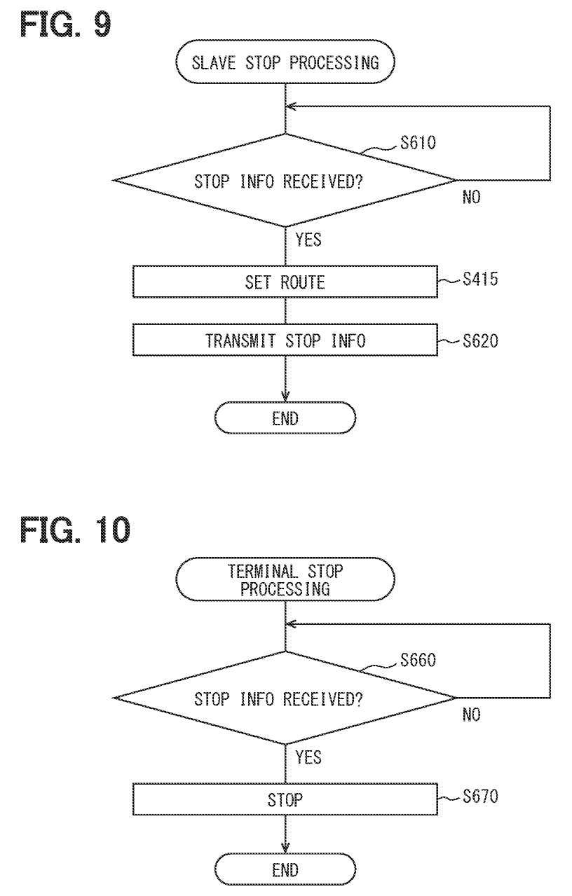

FIG. 9 is a flowchart showing the slave stop processing executed by the CPU 71, etc., for stopping the slave ECU 6. The slave stop processing is a process that starts, for example, when the power supply to the CPU 71, etc., is turned on. Also, the slave stop processing is executed, for example, by the control ECUs 3 and 4 when communication interruption is detected on the communication line 31 and communication is performed in the order of communication line 32, control ECU 4, communication line 34, control ECU 3, and communication bus 36.

In the slave stop processing, as shown in FIG. 9, first, in S610, the CPU 71, etc., determines whether an NM frame has been received. Here, it is specifically determined whether stop information has been received. The NM frame includes the configuration notification transmitted by the management ECU 2. If the NM frame has not been received, S610 is repeated. If the NM frame has been received, the process proceeds to S415.

Next, in S415, the CPU 71, etc., sets the communication to be performed via the new communication path according to the configuration notification. Then, in S620, the CPU 71, etc., relays the NM frame including the received stop information along the new communication path. For example, the control ECU 4 relays the NM frame to the control ECU 3, and the control ECU 3 relays the NM frame to the slave ECU 6. When this processing is completed, the present processing ends.

Next, FIG. 10 is a flowchart showing the terminal stop processing executed by the CPUs (not shown) of the slave ECUs 6-11. The terminal stop processing is a process that starts, for example, when the power supply to the slave ECUs 6-11 is turned on.

In the terminal stop processing, as shown in FIG. 10, first, in S660, the slave ECUs 6-11 determine whether an NM frame has been received. Here, it is specifically determined whether stop information has been received. If the NM frame has not been received, S660 is repeated. If the NM frame has been received, the process proceeds to S670.

Next, in S670, the slave ECUs 6-11 execute processing to stop their own device in accordance with the received stop information. That is, a shutdown is performed. When this processing is completed, the present processing ends.

Note that the processing for stopping the device is not limited to shutdown, and may be a process for entering a sleep state. Sleep is a state in which at least transmission of frames is stopped, and the power consumption is lower than in the normal state (for example, a state in which frames can be transmitted). The NM frame including stop information may be transmitted by the management ECU 2 or by the control ECUs 3, 4, and 5.

According to the second embodiment described in detail above, the following effects are achieved. The vehicle control system 1 is a system in which the management ECU 2 and a plurality of control ECUs 3, 4, and 5 managed by the management ECU 2 are each configured to be able to communicate with each other by selectively using one of a plurality of communication paths. Each device is connected, for example, in a ring configuration by the communication lines 31-35.

In S330, the CPU 51 of the management ECU 2 is configured such that, when it receives an abnormality notification indicating a notification capable of specifying the abnormal section in the communication path used before abnormality detection among the plurality of communication paths, it selects a new communication path avoiding the abnormal section. In S360, the CPU 51 of the management ECU 2 is configured to transmit a configuration notification to at least the plurality of control ECUs 3, 4, and 5, indicating that communication will be performed via the selected new communication path.

In S310, the CPU 51 of the management ECU 2 is configured to detect abnormalities in the communication path. In S325, the CPU 51 of the management ECU 2 is configured to notify the management ECU 2 internally of the abnormality notification related to the detected abnormality.

In S415, the CPUs 71, 91, and 111 of the plurality of control ECUs 3, 4, and 5 are configured to set the new communication path and perform communication according to the configuration notification. With such a configuration, when an abnormality occurs in the communication path, a new communication path avoiding the abnormal section can be established, and communication can be performed using this new communication path, thereby reducing the likelihood of an event where necessary communication cannot be performed.

The vehicle control system 1 further includes slave ECUs 6-11, which are devices communicably connected to at least one of the plurality of control ECUs 3, 4, and 5. In S370 and S530, the management ECU 2 is configured to calculate the processing wait time (for example, diagnostic mask time, SW OFF time) for itself or for the plurality of control ECUs 3, 4, and 5, taking into account the required waiting time related to the slave ECUs 6-11. The required waiting time includes, for example, communication delay time from the synchronization time, ECU activation time, and power-off time.

Further, in S450 and S550, the management ECU 2 and at least one of the plurality of control ECUs 3, 4, and 5 are configured to wait for the processing wait time before executing processing related to the target device.

Specifically, in S380, the CPU 51 of the management ECU 2 is configured to notify at least the plurality of control ECUs 3, 4, and 5 of the processing wait time. In S550, the CPU 51 of the management ECU 2 is configured to transmit a control instruction (for example, NM frame) to at least the plurality of control ECUs 3, 4, and 5 after waiting for the processing wait time.

With such a configuration, the processing wait time for the management ECU 2 or the plurality of control ECUs 3, 4, and 5 can be calculated in consideration of the required waiting time, and processing can be executed after waiting for the processing wait time.

In the vehicle control system 1, the management ECU 2, the plurality of control ECUs 3, 4, and 5, and the slave ECUs 6-11 may be configured to synchronize time for communication. In S370 and S530, the CPU 51 of the management ECU 2 is configured to calculate the communication delay time due to changes in the communication path as the processing wait time, taking into account the communication time required to reach the target device as the required waiting time.

With such a configuration, even if the communication delay time increases, it is possible to correct the synchronization time and set the processing timing in consideration of the increase. In the vehicle control system 1, the management ECU 2 is provided with a storage unit 43 configured to store the new communication path and the previous communication path before the new communication path is set. When the management ECU 2 is restarted, it is configured to start communication using the previous communication path.

With such a configuration, when the management ECU 2 is restarted, communication can be performed using the previous communication path as usual. This is effective in cases where restarting the management ECU 2 restores abnormalities in the communication path.

In the vehicle control system 1, the management ECU 2 may be provided with a storage unit 43 configured to store the new communication path and the previous communication path before the new communication path is set. When the management ECU 2 is restarted, it may start communication using the new communication path.

With such a configuration, when the management ECU 2 is restarted, communication can be performed using the new communication path. This is effective in cases where the situation does not improve even if the management ECU 2 is restarted, such as when there is physical damage to the communication path.

In the vehicle control system 1, in S360, the CPU 51 of the management ECU 2 is configured to transmit an activation command for activating the target device along the new communication path. In S370 and S530, the CPU 51 of the management ECU 2 is configured to calculate the diagnostic mask time for the target device as the processing wait time, taking into account the activation time of the target device as the required waiting time.

With such a configuration, it is possible to suppress erroneous determination that the target device is abnormal during the period until the target device is activated and operates normally. That is, it is possible to suppress erroneous diagnostic information from being stored in each device.

In the embodiments described above, S370 and S530 correspond to processing by the time calculation unit, and S450 and S550 correspond to processing by the processing execution unit. Although one embodiment of the present disclosure has been described above, the present disclosure is not limited to the above embodiment and may be implemented with various modifications.

### Modification 1

In the above embodiment, an acknowledgment is returned when an NM frame from the same sender has not yet been received within the same frame reception determination period. However, it is also possible to return an acknowledgment even when an NM frame from the same sender has already been received within the same frame reception determination period.

### Modification 2

In the second embodiment above, the management ECU 2 is configured to detect abnormalities in the communication path, but this is not limiting. Not only the management ECU 2, but at least one of the plurality of control ECUs 3, 4, and 5 may be provided with such a configuration.

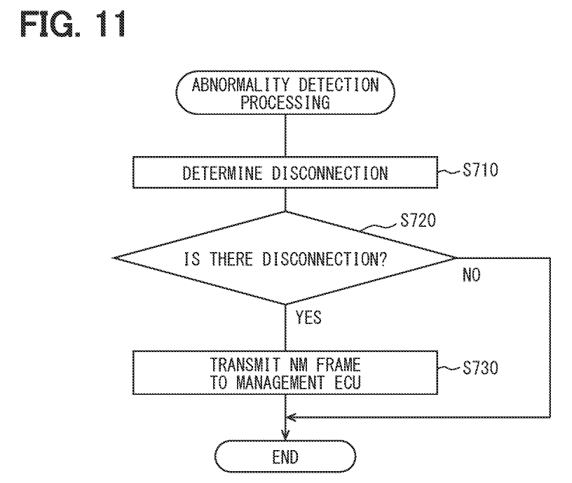

When the control ECUs 3, 4, and 5 detect abnormalities in the communication path, for example, the processing shown in FIG. 11 is executed. FIG. 11 is a flowchart showing the abnormality detection processing executed by the CPU 71, etc. The abnormality detection processing starts, for example, when the power supply to the control ECUs 3, 4, and 5 is turned on.

In the abnormality detection processing, as shown in FIG. 11, first, in S420, the CPU 71, etc., performs interruption determination. This processing is the same as S230 and S310 described above. Next, in S720, the CPU 71, etc., determines whether communication interruption has occurred. This processing is the same as S320 described above. If there is no communication interruption, the process returns to S710. If there is communication interruption, the process proceeds to S730.

In S730, the CPU 71, etc., transmits an NM frame to the management ECU 2. The NM frame here includes an abnormality notification. When an abnormality in the communication path is detected and the control ECUs 3-5 notify the management ECU 2 of the abnormality, for example, broadcast may be used. This is because the control ECUs 3-5 may not be aware of the network configuration (i.e., how each device is connected). However, if the control ECUs 3-5 are aware of the network configuration, the abnormality notification may be sent using a communication path to the management ECU 2. When this processing is completed, the present processing ends.

Note that when an abnormality notification is transmitted in this processing, the management ECU 2 may execute the processing from S325 onward in the master activation processing and master stop processing, and in S325, acquire the abnormality notification transmitted by the CPU 71, etc.

### Modification 3

In the second embodiment above, the system is configured to immediately change the communication path upon abnormality detection, but this is not limiting. Upon abnormality detection, if a predetermined event occurs or a predetermined condition is satisfied, the communication path may not be changed. In this case, when the vehicle power supply is shut off and then turned on again (for example, when the ignition is turned on), communication may be performed using the new communication path.

### Modification 4

In the second embodiment above, S360 describes an example in which only the slave ECU 6 is activated as the target device. However, when the control ECUs 3, 4, and 5 are in a sleep state, the control ECUs 3, 4, and 5 may be activated as the target device. In such a case, the CPU 51 of the management ECU 2 may transmit activation commands sequentially from the device closest to the starting point among the plurality of target devices, according to the connection order of the plurality of target devices in the new communication path. For example, when the management ECU 2, the control ECU 5, and the slave ECUs 10 and 11 are in a sleep state, and the slave ECU 10 is to be activated, the CPU 51 of the management ECU 2 may activate the control ECU 5 first and then activate the slave ECU 10.

With such a configuration, it is possible to sequentially activate each of a plurality of target devices in consideration of the connection order.

### Modification 5

In the first embodiment described above, a configuration was shown in which the slave ECUs 6, 7, 8, 9, 10, and 11 are switched between the on state and the off state by switching the power distribution switches 65, 66, 85, 86, 105, and 106 between the on state and the off state. However, the management ECU 2 may generate, as an NM frame, a communication frame including state specifying information capable of specifying whether each of the slave ECUs 6, 7, 8, 9, 10, and 11 is to be set to the wake-up state or the sleep state, and transmit the generated NM frame. As a result, the vehicle control system 1 can maintain the power distribution switches 65, 66, 85, 86, 105, and 106 in the on state and switch the slave ECUs 6, 7, 8, 9, 10, and 11 between the wake-up state and the sleep state based on the NM frame. Note that the wake-up state of the slave ECUs 6-11 corresponds to the on state of the electronic control unit, and the sleep state of the slave ECUs 6-11 corresponds to the off state of the electronic control unit.

In such a vehicle control system 1, even if the management ECU 2 cannot transmit an NM frame to the control ECU 3 via the communication line 31, the management ECU 2 can transmit the NM frame to the control ECU 3 via the communication line 32 and the communication line 34. As a result, the control ECU 3 can transmit the NM frame to the slave ECUs 6 and 7 via the communication bus 36. Therefore, the vehicle control system 1 can further suppress the inability to switch the slave ECUs 6 and 7 between the wake-up state and the sleep state.

### Modification 6

In the first embodiment described above, a configuration was shown in which the slave ECUs 6, 7, 8, 9, 10, and 11 are switched between the on state and the off state by switching the power distribution switches 65, 66, 85, 86, 105, and 106 between the on state and the off state. However, the management ECU 2 may generate, as an NM frame, a communication frame including state specifying information capable of specifying whether each of the control ECUs 3, 4 and the slave ECUs 6-11 is to be set to the wake-up state or the sleep state, and transmit the generated NM frame.

In such a vehicle control system 1, even if the management ECU 2 cannot transmit an NM frame to the control ECU 3 via the communication line 31, the management ECU 2 can transmit the NM frame to the control ECU 3 via the communication line 32 and the communication line 34. As a result, the control ECU 3 can switch between the wake-up state and the sleep state based on the NM frame received via the communication line 32 and the communication line 34. Therefore, the vehicle control system 1 can further suppress the inability to switch the control ECU 3 between the wake-up state and the sleep state.

### Modification 7

In the first embodiment described above, a configuration was shown in which an NM frame including six switching information items indicating whether each of the power distribution switches 65, 66, 85, 86, 105, and 106 is to be set to the on state or the off state is transmitted. However, the NM frame may be transmitted as an NM frame including state specifying information indicating the vehicle mode. The control ECUs 3, 4, and 5 may switch the power distribution switches 65, 66, 85, 86, 105, and 106 between the on state and the off state based on the vehicle mode indicated by the state specifying information included in the received NM frame.

For example, in the first vehicle mode, it is set such that the power distribution switch 65 is in the on state, the power distribution switch 66 is in the on state, the power distribution switch 85 is in the off state, the power distribution switch 86 is in the off state, the power distribution switch 105 is in the on state, and the power distribution switch 106 is in the off state.

For example, in the second vehicle mode, it is set such that the power distribution switch 65 is in the off state, the power distribution switch 66 is in the off state, the power distribution switch 85 is in the on state, the power distribution switch 86 is in the on state, the power distribution switch 105 is in the off state, and the power distribution switch 106 is in the on state.

The control units 41, 61, 81, and 101 and their methods described in the present disclosure may be implemented by a dedicated computer provided by configuring a processor and memory programmed to execute one or more functions embodied by a computer program. Alternatively, the control units 41, 61, 81, and 101 and their methods described in the present disclosure may be implemented by a dedicated computer provided by configuring a processor with one or more dedicated hardware logic circuits. Further, the control units 41, 61, 81, and 101 and their methods described in the present disclosure may be implemented by one or more dedicated computers configured by a combination of a processor and memory programmed to execute one or more functions and a processor configured with one or more hardware logic circuits. Moreover, the computer program may be stored as instructions executable by a computer on a computer-readable non-transitory tangible recording medium. The methods for realizing the functions of each part included in the control units 41, 61, 81, and 101 do not necessarily have to include software, and all functions may be realized using one or more hardware components.

The multiple functions possessed by one component in the above embodiments may be realized by a plurality of components, or one function possessed by one component may be realized by a plurality of components. Furthermore, multiple functions possessed by a plurality of components may be realized by one component, or one function realized by a plurality of components may be realized by one component. Additionally, part of the configuration of the above embodiments may be omitted. At least a part of the configuration of the above embodiments may be added to or replaced with the configuration of another embodiment described above.

In addition to the ECUs 2-5 described above, the present disclosure may also be realized in various forms, such as a system including the ECUs 2-5 as components, a program for causing a computer to function as the ECUs 2-5, a non-transitory tangible recording medium such as a semiconductor memory on which this program is recorded, and a communication control method.

What is claimed is:

1. A communication system comprising
a plurality of electronic control units connected for transmitting and receiving a communication frame, the electronic control units including:
a first control device configured to receive power supply via a first power supply path;
a second control device configured to receive power supply via a second power supply path not connected to the first power supply path;
a first slave device configured to receive power supply via a third power supply path connected to the first power supply path;
a second slave device configured to receive power supply via a fourth power supply path connected to the second power supply path; and
a management device configured to generate a management frame, which is the communication frame including state specifying information capable of specifying whether each of the plurality of electronic control units is to be set to an on state or an off state in accordance with a detected event,
a first communication path configured to connect the management device and the first control device for transmitting and receiving the communication frame between the management device and the first control device,
a second communication path configured to connect the management device and the second control device for transmitting and receiving the communication frame between the management device and the second control device, and
a relay communication path configured to connect the first control device and the second control device for transmitting and receiving the communication frame between the first control device and the second control device,
wherein
the management device is configured to transmit the management frame to the first control device via the first communication path,
the management device is configured to transmit the management frame to the second control device via the second communication path,
the first control device and the first slave device are connected to enable data communication with each other, and
the second control device and the second slave device are connected to enable data communication with each other.

2. The communication system according to claim 1, further comprising:
a first power supply switching unit configured to switch between an on state in which the third power supply path is conductive and an off state in which the third power supply path is interrupted; and
a second power supply switching unit configured to switch between an on state in which the fourth power supply path is conductive and an off state in which the fourth power supply path is interrupted;
wherein
the first control device is configured to control operation of the first power supply switching unit based on the state specifying information included in the management frame, and
the second control device is configured to control operation of the second power supply switching unit based on the state specifying information included in the management frame.

3. The communication system according to claim 2, wherein
the first control device is configured to transmit the management frame received from the management device to the second control device via the relay communication path, even when the second communication path is available, and
the second control device is configured to transmit the management frame received from the management device to the first control device via the relay communication path, even when the first communication path is available.

4. The communication system according to claim 2, wherein:
the electronic control units further include
a third control device configured to receive power supply via a fifth power supply path not connected to the first power supply path and connected to the second power supply path;
a third slave device configured to receive power supply via a sixth power supply path connected to the fifth power supply path; and
a third power supply switching unit configured to switch between an on state in which the sixth power supply path is conductive and an off state in which the sixth power supply path is interrupted,
the communication system further comprises
a third communication path configured to connect the management device and the third control device for transmitting and receiving the communication frame between the management device and the third control device; and
a second relay communication path configured to connect the second control device and the third control device for transmitting and receiving the communication frame between the second control device and the third control device, the relay communication path being as a first relay communication path,
wherein
the state specifying information further includes information indicating whether the third power supply switching unit is to be set to an on state or an off state,
the management device is configured to transmit the management frame to the third control device via the third communication path, and
the third control device is configured to control operation of the third power supply switching unit based on the state specifying information included in the management frame.

5. The communication system according to claim 2, wherein
the first control device is configured to set the first power supply switching unit to the on state or the off state based on the earliest received management frame when the management frame is received from each of a plurality of communication paths connected to the first control device within a preset first same frame reception determination period; and
the second control device is configured to set the second power supply switching unit to the on state or the off state based on the earliest received management frame when the management frame is received from each of a plurality of communication paths connected to the second control device within a preset second same frame reception determination period.

6. The communication system according to claim 2, wherein
the first control device includes a first communication interruption determination unit configured to determine that communication interruption has occurred in the communication path in which the management frame is not periodically received when the management frame is periodically received in at least one of the plurality of communication paths connected to the first control device and the management frame is not periodically received in at least one of the plurality of communication paths connected to the first control device; and
the second control device includes a second communication interruption determination unit configured to determine that communication interruption has occurred in the communication path in which the management frame is not periodically received when the management frame is periodically received in at least one of the plurality of communication paths connected to the second control device and the management frame is not periodically received in at least one of the plurality of communication paths connected to the second control device.

7. The communication system according to claim 6, wherein
the first control device further includes a first interruption notification unit configured to notify the management device of a determination result by the first communication interruption determination unit when the first communication interruption determination unit determines that communication interruption has occurred; and
the second control device further includes a second interruption notification unit configured to notify the management device of a determination result by the second communication interruption determination unit when the second communication interruption determination unit determines that communication interruption has occurred.

8. The communication system according to claim 2, wherein
the management device further includes a time calculation unit configured to take into account a required waiting time related to the first slave device and calculate a processing wait time for the management device or the first control device; and
at least one of the management device and the first control device further includes a processing execution unit configured to execute processing related to the first slave device after waiting for the processing wait time.

9. A communication system comprising
a plurality of electronic control units connected for transmitting and receiving a communication frame, the electronic control units including:
a first control device configured to receive power supply via a first power supply path; and
a second control device configured to receive power supply via a second power supply path not connected to the first power supply path,
a first power supply switching unit configured to switch a third power supply path, which supplies power to a first slave device connected to the first power supply path and is connected to enable data communication with the first control device, between an on state in which the third power supply path is conductive and an off state in which the third power supply path is interrupted;
a second power supply switching unit configured to switch a fourth power supply path for supplying power to a second slave device, which is connected to the second power supply path and is connected to enable data communication with the second control device, between an on state in which the fourth power supply path is conductive and an off state in which the fourth power supply path is interrupted;
a management device, as the electronic control unit, configured to generate a management frame, which is the communication frame including state specifying information capable of specifying whether each of the plurality of electronic control units is to be set to an on state or an off state in accordance with a detected event;
a first communication path configured to connect the management device and the first control device for transmitting and receiving the communication frame between the management device and the first control device;
a second communication path configured to connect the management device and the second control device for transmitting and receiving the communication frame between the management device and the second control device; and
a relay communication path configured to connect the first control device and the second control device for transmitting and receiving the communication frame between the first control device and the second control device,
wherein
the management device is configured to transmit the management frame to the first control device via the first communication path,
the management device is configured to transmit the management frame to the second control device via the second communication path,
the first control device is configured to control operation of the first power supply switching unit based on the state specifying information included in the management frame, and
the second control device is configured to control operation of the second power supply switching unit based on the state specifying information included in the management frame.
